(19) United States
(12) Patent Application Publication
(10) Pub. No.: US 2023/0399885 A1
(43) Pub. Date: Dec. 14, 2023

(54) Anordnung mit einem Deckel zum Abdecken eines Ladeanschlusses eines insbesondere zumindest teilweise elektrischen Kraftfahrzeugs

(71) Applicant: fischer automotive systems GmbH & Co. KG, Horb a.N (DE)

(72) Inventors: Ulf-Lothar Bastian, Pfalzgrafenweiler (DE); Gunter Leopold, Baiersbronn (DE)

(21) Appl. No.: 18/311,720

(22) Filed: May 3, 2023

(30) Foreign Application Priority Data
May 5, 2022 (DE) 10 2022 111 168.7

(51) Int. Cl. E05F 15/611

(52) U.S. Cl. CPC E05F 15/611; B60L 53/14

(57) ABSTRACT

A system comprising a cover for closing a charging opening of an electric vehicle in which a charging socket for charging a driving battery of the electric vehicle is located. The cover is mounted laterally next to the charging opening, on an inner side of the body part, so as to be pivotable about a first pivot axis by way of a hinge arm and can be pivoted by way of an electromechanical actuator. For activating the actuator, the invention provides a pivotable transfer body, which multiplies a path of the cover and activates the actuator by way of a push button.

The invention relates to a system comprising a cover for covering a charging connection of an in particular partially electric motor vehicle having the features of the preamble of claim 1.

Patent application JP 2023-19203 A describes a system comprising a cover for covering a tank filler neck, a charging connection, or the like, of a motor vehicle, wherein the cover can be moved between a closed position, in which the cover closes a body opening in a flush manner, and an open position, in which the cover is located next to, beneath, or above the body opening on an outer side of a body, using two parallel pivoting levers. The cover is driven by an actuator, which pivots one of the two pivoting levers from the closed position into the open position, and vice versa. For opening, the actuator is triggered by pushing the cover from the closed position slightly inwardly.

It is the object of the invention to provide a system of the above-described kind, which shortens a path of a cover from a closed position inward for activating an actuator or for triggering a function.

According to the invention, this object is achieved by the features of claim 1. The system according to the invention comprises a cover for covering a charging connection in a charging bay body of an in particular at least partially electric motor vehicle, which can be moved back and forth between a closed position and an open position. When closed, the cover covers the charging connection. In particular, when closed, the cover is located in a charging opening of a body of the motor vehicle so that the cover closes the charging opening, and an outer side of the cover is flush with an outer side of the body. When open, the cover exposes the charging bay body so that the charging connection can be accessed for plugging in a charging cable or a charging plug. In particular, when open, the cover is located completely, or in any case substantially, next to, above, or beneath the charging opening so that it is possible to plug the charging cable or charging plug into the charging connection unhindered, or with only little hindrance, by the cover in the open position.

In particular, the system comprises an actuator for opening the cover, which is to say for moving the cover from the closed position into the open position. The cover can likewise be closed by way of the actuator, or in another manner, for example by hand. Designs of the invention without an actuator are also possible, in which the cover is opened by hand, for example. An actuator shall be understood to mean a drive unit that generates mechanical movement. Designs of the invention including the actuator are likewise possible, wherein the actuator moves something other than the cover.

The invention provides an electrical switching unit for activating, which is to say for starting, the actuator so that the actuator opens the cover, the electrical switching unit in particular comprising a push button. Instead of activating the actuator, or in addition to activating the actuator, the electrical switching unit can also trigger another function, for example switching on a charging light or actuating a locking mechanism, which protects the cover against being opened otherwise. As a result, an actuator is not provided in all instances for opening the cover. The electrical switching unit is actuated by moving the cover from the closed position inwardly, which is to say, in order to actuate the electrical switching unit, the cover is moved, beyond the closed position, a short distance further in a closing direction oriented opposite the opening movement. The electrical switching unit can also be interpreted as a signal generator, which generates or modifies an electrical signal when the cover is moved from the closed position inwardly.

The invention provides a movable multiplication member between the electrical switching unit and the cover, the multiplication member being moved from the closed position inwardly by the movement of the cover, multiplying the movement of the cover, and actuating the electrical switching unit. The multiplication member is, in particular, disposed between the cover and the electrical switching unit, wherein “between” at any rate shall be understood to mean an operative arrangement of the multiplication member between the cover and the electrical switching unit, regardless of a spatial arrangement of the multiplication member. “Multiplying” shall be understood to mean that the movement of the cover is extended, which is to say a point of the multiplication member which actuates the electrical switching unit moves further than a point of the multiplication member which is moved by the cover. According to the invention, the cover thus does not actuate the electrical switching unit directly, but indirectly by way of the multiplication member, which multiplies the movement of the cover.

In particular, the cover moves the multiplication member by striking with an inner side against the multiplication member when the cover is moved from the dosed position inwardly.

In some designs of the invention, the cover does not move the multiplication member over the entire path thereof, but essentially only when the cover is moved from the dosed position inwardly. The cover can also already move the multiplication member slightly before or not move the multiplication member until slightly after the closed position.

By multiplying the path from the cover to the electrical switching unit by way of the multiplication member, a shorter path of the cover from the closed position inwardly suffices for actuating the electrical switching unit. This is advantageous in instances where the electrical switching unit is disposed accordingly low, and the cover cannot be moved sufficiently far from the closed position inwardly to activate the switching unit.

The dependent claims relate to advantageous embodiments and refinements of the invention.

The cover can, generally, be movable in any translatory and/or rotatory manner. For example, the system according to the invention can comprise a sliding guide for the cover or the pivoting lever, by way of which the cover is guided in the manner of a parallelogram or with a planar four-bar linkage. The cover can preferably be pivoted about a first pivot axis, or is guided by way of pivoting levers, which do not have to be parallel to one another, so as to be movable back and forth between the closed position and the open position.

An embodiment of the invention provides for the multiplication member to comprise a transfer body, which can be pivoted about a second pivot axis. The transfer body is pivoted about the second pivot axis by the cover in an actuating direction when the cover is pushed from the closed position inwardly. During the pivoting in the actuating direction, the transfer body actuates the electrical switching unit.

The transfer body, in particular, comprises two lever arms, and more particularly a first and shorter lever arm, at which the cover of the system according to the invention engages on the transfer body when the cover is being moved from the closed position inwardly, and a second and longer lever arm, by way of which the transfer body actuates the electrical switching unit. The first lever arm shall, in particular, be understood as a distance with respect to the second pivot axis, which is to say with respect to the pivot axis of the transfer body, at which the cover engages on the transfer body when moving from the dosed position inwardly. The second lever arm is, in particular, a distance with respect to the second pivot axis by way of which the transfer body actuates the electrical switching element. The lever arms do not necessarily presuppose levers, but can, generally speaking, also be distances with respect to the second pivot axis, which is to say with respect to the pivot axis of the transfer body.

The two lever arms can project from the pivot axis of the transfer body in opposite directions, in the same direction, or in differing directions.

An embodiment of the invention provides for the transfer body to have an angled section at a radial distance with respect to the second pivot axis, by way of which the transfer body actuates the electrical switching unit. Such an angled section is also possible for moving the transfer body with the cover. The angled section, for example, makes it possible to extend around an obstacle that, in the absence of the angled section, would be in the way of the pivoting movement of the transfer body, or to “lower” the angled section into an opening during the pivoting movement of the transfer body.

An embodiment of the invention provides an elevation, which projects from the inner side of the cover in the direction of the transfer body, as an actuating element for actuating the electrical switching unit. This elevation corresponds to a protrusion at the transfer body, which projects from the transfer body in the direction of the elevation. The elevation at the inner side of the cover and the protrusion at the transfer body are disposed and designed so that the elevation strikes against the protrusion when the cover is pushed from the closed position inwardly. When the cover is pushed from the closed position inwardly, the elevation strikes against the protrusion so that the cover pivots the transfer body in the actuating direction, whereby the transfer body actuates the electrical switching unit.

A distance between the protrusion of the transfer body and the second pivot axis about which the transfer body can be pivoted is preferably smaller than a distance between the angled section of the transfer body for actuating the electrical switching unit and the second pivot axis. As a result, the desired path multiplication from the cover to the electrical switching unit is achieved. The distance between the protrusion at the transfer body and the second pivot axis can also be interpreted as a first and shorter lever arm, and the distance between the angled section of the transfer body for actuating the electrical switching unit and the second pivot axis can also be interpreted as a second and longer lever arm.

The first pivot axis, about which the cover can be pivoted, and the second pivot axis, about which the transfer body can be pivoted, are preferably stationary with respect to the charging bay body and/or parallel to one another.

A preferred embodiment of the invention provides a curved hinge arm, which projects, rigidly in some designs of the invention, from the inner side of the cover and which can be pivoted about the first pivot axis, so that the cover can be pivoted about the first pivot axis back and forth between the closed position and the open position by way of the hinge arm. This embodiment of the invention makes it possible to dispose the first pivot axis at an inner side of the body of the motor vehicle next to, beneath, or above the charging opening in a way that is not visible from the outside. The hinge arm is in particular curved so as to embrace an edge of the charging opening in the body, when the cover is open, from the first pivot axis at the inner side of the body to the cover, which, when open, is located outside the body.

The features and feature combinations, designs, and embodiments of the invention mentioned above in the description, and the features and feature combinations mentioned hereafter in the description of the figures and/or shown in a figure, can be used not only in the respective indicated or illustrated combination, but also in other essentially arbitrary combinations, or alone. Designs of the invention that do not include all the features of a dependent claim are possible. It is also possible to replace individual features of a claim with other disclosed features or feature combinations. Designs of the invention that do not include all the features of the exemplary embodiment, but an essentially arbitrary portion of the characterizing features of the exemplary embodiment, are possible.

The invention will be described hereafter based on an exemplary embodiment shown in the drawings. In the drawings:

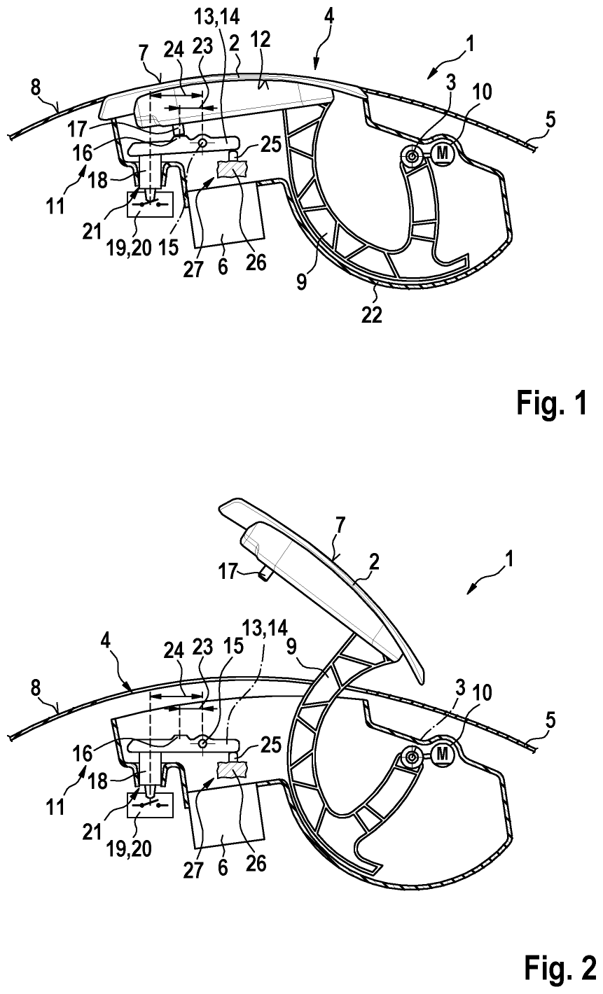

FIG. 1 shows a system comprising a cover for covering a charging socket of an electric car according to the invention, with the cover in a closed position;

FIG. 2 shows the system from FIG. 1, with the cover in an intermediate position; and

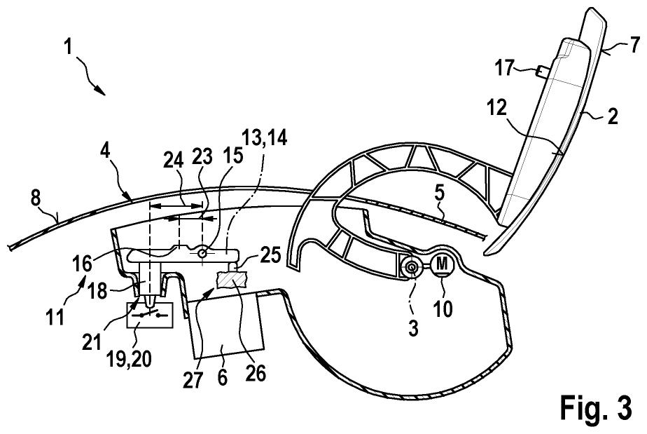

FIG. 3 shows the system from FIGS. 1 and 2, with the cover in an open position.

The drawings are schematic and partially simplified illustrations to provide an understanding of and to describe the invention.

The system 1 according to the invention shown in the drawings comprises a cover 2, which can be pivoted back and forth about a first pivot axis 3 between a closed position, which is shown in FIG. 1, and an open position, which is shown in FIG. 3. FIG. 2 shows an intermediate position of the cover 2 between the closed position and the open position.

In the closed position, the cover 2 is located in a charging opening 4 of a body part 5, such as a fender of a motor vehicle, which is not shown further, closes the charging opening 4, and covers a charging socket 6, which is recessed in the charging opening 4 or located behind the charging opening 4. The charging socket 6 is used for charging a driving battery, which is a rechargeable battery, of a motor vehicle, which is an electric car.

When closed, the cover 2 is flush with the body part 5, which is to say an outer side 7 of the cover 2 is flush with an outer side 8 of the body part 5 in a region of the body part 5 surrounding the charging opening 4 (FIG. 1).

When open, the cover 2 projects, for example perpendicularly in the exemplary embodiment, from the body part 5 on the outer side 8 of the body part 5 (FIG. 3).

The cover 2 comprises a hinge arm 9, which projects rigidly from an inner side 12 of the cover 2 near an edge of the cover 2. In the exemplary embodiment, the hinge arm 9 is integral with the cover 2. The first pivot axis 3, about which the cover 2 can be pivoted, extends parallel to the outer side 7 of the cover 2 and the outer side 8 of the body part 5, wherein the first pivot axis 3 is situated on an inner side 11 of the body part 5, laterally next to the charging opening 4. An end of the hinge arm 9 lying furthest from the cover 2 is mounted so as to be pivotable about the first pivot axis 3, whereby the cover 2 can also be pivoted about the first pivot axis 3. During pivoting, the cover 2 carries out a movement on a circular path about the first pivot axis 3.

The hinge arm 9 is curved and, as viewed parallel to the first pivot axis 3, has an approximately V shape having approximately circular arc-shaped legs and an apex rounded in an arc shape. When the cover 2 is open, one of the legs of the “V” of the hinge arm 9 is located on the inner side 11 of the body part 5, and the apex of the “V” embraces the edge of the charging opening 4 in one location.

For opening and closing the cover 2, the system 1 according to the invention comprises an actuator 10, which in the exemplary embodiment is an electromechanical actuator 10 and comprises a gear motor. The drawings show the actuator 10 as a graphical symbol in a simplified illustration. The actuator 10 pivots the hinge arm 9 about the first pivot axis 3, wherein the actuator 10 also pivots or moves the cover 2 about the first pivot axis 3 on a circular arc. The cover 2 can be pivoted about the pivot axis 3, back and forth between the closed position and the open position, by way of the actuator 10.

“Opening” shall be understood to mean moving or pivoting the cover 2 from the closed position into the open position, and “closing” shall be understood to mean moving or pivoting the cover 2 from the open position into the closed position.

According to the invention, the actuator 10 is activated for opening the cover 2 in that the cover 2 is moved from the closed position inwardly, which is to say a short distance in a closing direction beyond the closed position. The closing direction is a movement of the cover 2 from the direction of the open position in the direction of the closed position, and possibly beyond the closed position, inwardly to the inner side 11 of the body part 5.

A multiplication member 13, which in the exemplary embodiment comprises a transfer body 14, which in the exemplary embodiment is a pivoting lever, is disposed on the inner side 12 of the cover 2 for activating the actuator 10. The transfer body 14 can be pivoted about a second pivot axis 15.

Spaced apart from the second pivot axis 15, the transfer body 14 has a protrusion 16, which projects in the direction of the cover 2 and against which an elevation 17 at the inner side 12 of the cover 2 strikes when the cover 2 is moved from the closed position inwardly. The elevation 17 at the inner side 12 of the cover 2 is referred to as an actuating element here and, in the exemplary embodiment, has the shape of a pin. When moved from the closed position inwardly, the cover 2 pivots the transfer body 14 in an actuating direction by way of the actuating element thereof.

At one end, the transfer body 14 has an angled section 18, which strikes against a push button 19 and actuates the push button 19 when the transfer body 14 is pivoted from the closed position inwardly in the actuating direction as a result of the movement of the cover 2. Upon actuation, the push button 19, which, generally speaking, can also be interpreted as an electrical switching unit, activates the actuator 10 so that the actuator 10 opens the cover 2, which is to say pivots it about the first pivot axis 3 in the circular arc into the open position.

Instead of activating the actuator 10, or in addition to activating the actuator 10, it is also possible for a different function to be triggered by way of the electrical switching unit 20.

A distance between the angled section 18 of the transfer body 14 and the second pivot axis 15 is greater than the distance between the protrusion 16 and the second pivot axis 15, whereby, upon the actuation of the electrical switching unit 20, a path from the cover 2 to the electrical switching unit 20 is multiplied by way of the transfer body 14 of the multiplication member 13. “Path multiplication” shah be understood to mean that the path of the angled section 18 is longer than the path of the cover 2 from the closed position inwardly. As a result, a short path of the cover 2 from the closed position inwardly suffices for actuating the electrical switching unit 20 and activating the actuator 10.

The angled section 18 of the transfer body 14 allows components on the inner side 11 of the body part 5 to be circumvented. In the exemplary embodiment, the angled section 18 protrudes through an opening 21 of a charging bay body 22.

The distance between the protrusion 16 of the transfer body 14, in which the elevation 17 of the cover 2 strikes against the transfer body 14, and the second pivot axis 15 can also be interpreted as a first lever arm 23, and the distance between the angled section 18, by way of which the transfer body 14 actuates the push button 19 or the electrical switching unit 20, and the second pivot axis 15 can also be interpreted as a second lever arm 24. For multiplying the path from the cover 2 to the push button 19 or to the electrical switching unit 20, the second lever arm 24 is longer than the first lever arm 23.

In the exemplary embodiment, the two lever arms 23, 24 project from the second pivot axis 15 in the same direction. However, designs in which the two lever arms 23, 24 project from the second pivot axis 15 in opposite directions or in differing directions are also possible (not shown).

At an end located opposite the angled section 18, the transfer body 14 comprises a pin, serving as a stop 25, which rests against an abutment 26 when the cover 2 has not been moved from the closed position inwardly. The stop 25 and the abutment 26 form a pivot angle limiter 27, which limits a pivot angle of the transfer body 14 counter to the actuating direction.

In the exemplary embodiment of the invention, the first pivot axis 3, about which the cover 2 can be pivoted by way of the hinge arm 9 thereof, and the second pivot axis 15, about which the transfer body 14 can be pivoted, are disposed parallel to one another and parallel to a tangential plane with respect to the outer side 8 of the body part 5 on the inner side 11 of the body part 5.

The charging bay body 22 is fixedly disposed at the inner side 11 of the body part 5 and has an opening, which is congruent with the charging opening 4 in the body part 5. In the charging bay body 22, the two pivot axes 3, 15 are stationary, the hinge arm 9 of the cover 2 can be pivoted about the first pivot axis 3, and the transfer body 14 of the multiplication member 13 can be pivoted about the second pivot axis 15, and the actuator 10, the electrical switching unit 20, and the charging socket 6 are stationary. When the cover 2 is open, the charging socket 6 is freely accessible through the charging opening 4 in the body part 5 for plugging in a charging cable for a driving battery of the motor vehicle or electric car.

In contrast to the schematic illustrations in the drawings, the transfer body 14 does not conceal the charging socket 6, but the transfer body 14 is disposed in the charging bay body 22 next to, above, or beneath the charging socket 6 so as not to impede the plugging-in of the charging cable.

### LIST OF REFERENCE NUMERALS

### System comprising a cover for covering a charging connection of an in particular at least partially electric motor vehicle

1 system
2 cover
3 first pivot axis
4 charging opening
5 body part
6 charging socket
7 outer side of the cover 2
8 outer side of the body part 5
9 hinge arm
10 actuator
11 inner side of the body part 5
12 inner side of the cover 2
13 multiplication member
14 transfer body
15 second pivot axis
16 protrusion
17 elevation
18 angled section
19 push button
20 electrical switching unit
21 opening
22 charging bay body
23 first lever arm
24 second lever arm
25 stop
26 abutment
27 pivot angle limiter

1. A system, comprising a cover for covering a charging connection in a charging bay body of an in particular at least partially electric motor vehicle, the cover being movable so that the cover can be moved back and forth between a closed position, in which the cover covers the charging bay body, and an open position, in which the cover exposes the charging bay body, the cover including an outer side and an inner side, the system comprising an electrical actuator for moving the cover, and an electrical switching unit for activating the actuator, and the electrical switching unit being actuatable by a force on the outer side of the cover in the closed position thereof and activating the actuator for moving the cover into the open position, wherein a movable multiplication member is disposed between the electrical switching unit and the cover, the multiplication member being moved from the closed position inwardly by a movement of the cover, extending the movement, and actuating the electrical switching unit.

2. The system according to claim 1, wherein
the cover can be pivoted about a first pivot axis.

3. The system according to claim 1, wherein
the multiplication member comprises a transfer body, which can be pivoted about a second pivot axis and which is pivoted by the cover about the second pivot axis in an actuating direction when the cover is being moved from the closed position inwardly so that the transfer body actuates the electrical switching unit.

4. The system according to claim 3, wherein
the transfer body comprises a first lever arm, on which the cover engages, and a second lever arm, by way of which the transfer body actuates the electrical switching unit, and in that the second lever arm is longer than the first lever arm.

5. The system according to claim 3, wherein
that the transfer body comprises an angled section, spaced apart from the second pivot axis for pivoting the transfer body together with the cover and/or an angled section for actuating the electrical switching unit.

6. The system according to claim 3, wherein the system comprises a pivot angle limiter for the transfer body, which limits a pivot angle of the transfer body about the second pivot axis.

7. The system according to claim 3,
wherein the cover, at the inner side thereof, comprises an elevation, serving as an actuating element, which projects in the direction of the transfer body, for pivoting the transfer body about the second pivot axis so as to actuate the electrical switching unit, the elevation of the cover corresponding to a protrusion projecting from the transfer body in the direction of the elevation.

8. The system according to claim 5, wherein a distance between the second pivot axis and the protrusion at the transfer body is smaller than a distance between the second pivot axis and the angled section of the transfer body for actuating the electrical switching unit.

9. The system according to
claim 2, wherein the first pivot axis and the second pivot axis are stationary and/or parallel to one another.

10. The system according to
claim 2, characterized in that wherein the cover, at the inner side thereof, comprises a curved hinge arm, the hinge arm being pivotable about the first pivot axis and, as a result, the cover being pivotable back and forth between the open position and the closed position.
